(19) United States
(12) Patent Application Publication
(10) Pub. No.: US 2003/0046659 A1
(43) Pub. Date: Mar. 6, 2003

(54) Code generator for viterbi algorithm

(76) Inventor: Shimon Samoocha, Herzelia (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 10/173,681

(22) Filed: Jun. 18, 2002

Related U.S. Application Data
(60) Provisional application No. 60/298,916, filed on Jun. 19, 2001.

(51) Int. Cl. G06F 9/44

(52) U.S. Cl. 717/106

(57) ABSTRACT

Briefly, in one example of the present invention, a code generator automatically produces Viterbi algorithm code for the architecture of a general-purpose processor. Upon input of version parameters such as, but not limited to, the generator polynomials, the constraint length and the rate, the code generator produces versions of Viterbi algorithm code for use in the processor. In another example, a code generator produces a description of a Viterbi accelerator. The processor may be a digital signal processor.

### CROSS-REFERENCE TO RELATED APPLICATIONS

This application claims the benefit of and priority to U.S. provisional application Ser. No. 60/298,916 entitled “OPTIMIZED ASSEMBLY CODE GENERATOR FOR DSP OF VITERBI ALGORITHM CHANEL CODING” filed Jun. 19, 2001.

### RESERVATION OF COPYRIGHT

A portion of the disclosure of this patent document contains material to which a claim of copyright protection is made. The copyright owner has no objection to the facsimile reproduction by anyone of the patent document or the patent disclosure as it appears in the Patent and Trademark Office patent file or records, but reserves all other rights whatsoever.

### BACKGROUND OF THE INVENTION

When developing Viterbi algorithm code, the software programmer typically takes into account the particular architecture of the processor that will be running the code in order to produce code that exploits the architectural features of the processor. Knowledge of the specific instructions available to the processor, the duration of the computational pipeline, and the processor's ability to process instructions in parallel may determine how the code is written.

In some communication protocols, the Viterbi algorithm appears in several versions, each- version with different parameters such as, but not limited to, the generator polynomials of the convolution code, the constraint length and the rate. It is time consuming to write Viterbi algorithm code for each of these versions for a particular architecture. Moreover, the process of writing Viterbi algorithm code will be repeated several times as new processor architectures are being developed.

Thus, it would be beneficial to reduce the time required to develop Viterbi algorithm code.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified flowchart illustration of a method according to an embodiment of the present invention; and

FIG. 2 is a simplified illustration of an exemplary butterfly, helpful in understanding the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures and components have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Some embodiments of the present invention are directed towards a code generator that receives generator polynomials as parameters and generates Viterbi algorithm assembly code. If desired, the code generator may be rewritten for each processor in order to exploit the architectural features of the processor that is to execute the code. In that case, the Viterbi algorithm assembly code generated by the code generator may be “optimized” for the particular architecture in that manually programmed Viterbi algorithm assembly code will not have a better cycle count than the generated code. The code generator may be modified in order to reduce the code size of the generated code.

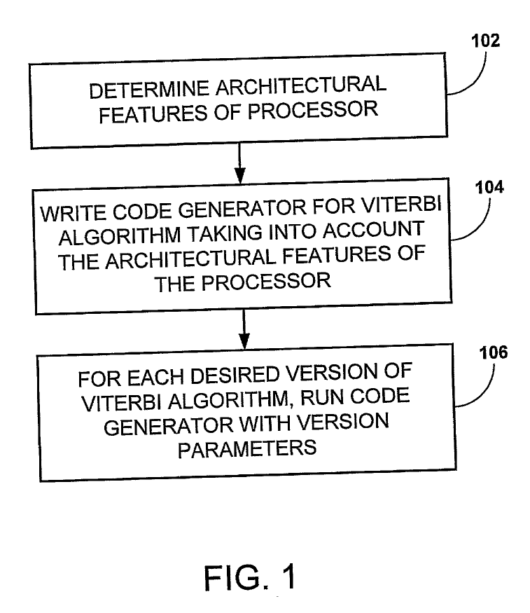

Reference is now made to FIG. 1, which is a simplified flowchart illustration of a method according to an embodiment of the present invention. For a particular processor, which may be, for example, a digital signal processor (DSP), a central processing unit (CPU), or a reduced instruction set computer (RISC), the architectural features of the processor are determined (block 102). Although the scope of the present invention is not limited in this respect, the architectural features that may be determined may include, for example, the specific instructions available to the processor, the duration of the computational pipeline, the processor's ability to process instructions in parallel, and the number and size of registers.

A code generator for the Viterbi algorithm is written, possibly taking into account the architectural features that were determined (block 104).

For each version of the Viterbi algorithm that is to be executed by the processor, the code generator is run with the version parameters to produce Viterbi algorithm code (block 106). Although the scope of the present invention is not limited in this respect, in the case of Viterbi algorithm decoding of convolution codes, the version parameters may include, for example, the generator polynomials of the convolution code, the constraint length and the rate.

As is well known in the art, the Viterbi algorithm involves a) branch metric computations, b) calculations of butterflies (including the selection of the branch metric values for use in the calculations), and c) traceback. The portion of the Viterbi algorithm code dealing with computation of branch metric values is dependent upon the number of generator polynomials. In some processor architectures, where the branch metric register contains two different branch metrics of the two upcoming butterflies, a code generator may be useful. The portion of the Viterbi algorithm code dealing with butterfly calculations is lengthy and dependent upon the generator polynomials. The portion of the Viterbi algorithm code dealing with traceback is the same for all versions of the Viterbi algorithm with the same constraint length and does not depend on the particular generator polynomials. Therefore, it may be unnecessary to use a code generator to produce this portion of the code.

### Butterfly Calculations

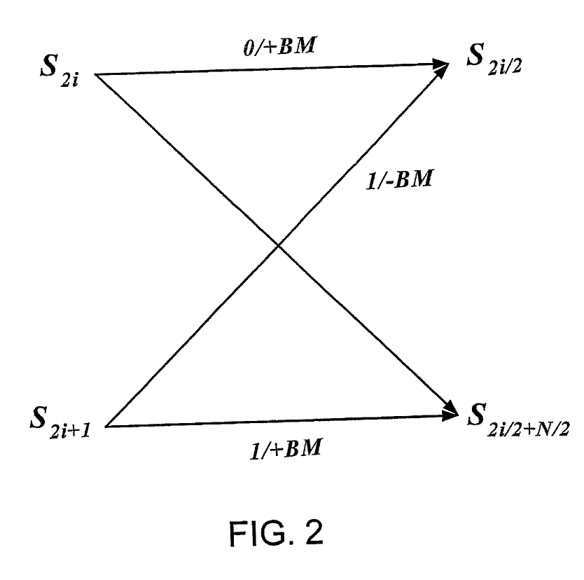

Reference is now made to FIG. 2, which is a simplified illustration of an exemplary butterfly. As is well known in the art, the butterfly calculation involves two add-compare-select processes. From an assembly code perspective, the following instructions will be required:

i) two memory read instructions (reading the value of the state S₂ᵢ and the state S_{2i+I} from memory);

ii) two addition instructions and two subtraction instructions involving the values of the states S₂ᵢ and S_{2i+I} and the branch metric value BM for the butterfly;

iii) two maximum instructions (including a comparison so that not only the maximum value is identified, but also a trace bit indicating which branch yielded the maximum value is generated); and

iv) two store in memory instructions (storing the results of the maximum instructions), and two store instructions for the flags.

It will be appreciated by persons of ordinary skill in the art that trace bits may be stored in output registers using a “Rotate” instruction. Once the register is full, it may be stored to memory. However, other implementations of storing the trace bits, or perhaps other ways to indicate which branch of the butterfly was used in the transition to a new state, are also within the scope of the present invention.

Various exemplary code generators for butterfly calculations will now be described. In a first example, the processor architecture enables the following instructions to be performed in the same cycle: Read*2, Add/Sub*4, Max*2, Store*2, Rotate*2. It will be understood by persons of ordinary skill in the art that “Read*2” indicates two read memory instructions, “Add/Sub*4” indicates four addition or subtraction instructions, “Max*2” indicates two maximum instructions, “Store*2” indicates two store memory instructions, and “Rotate*2” indicates two rotate shift register instructions. For purposes of clarity, the operands of these instructions are not shown.

This first example of processor architecture will have a computational pipeline of 4 cycles. In this example, the trace bits are stored in two output registers of 16 bits each. In this example, the butterfly calculations in Viterbi algorithm code will have the following format, where each line of code is a single cycle, and ∥ indicates instructions that occur in parallel:

| | | | | | | | | |
|---|---|---|---|---|---|---|---|---|
| Read*2 | | | | | | | | |
| Read*2 | \|\| | Add/Sub*4 | | | | | | |
| Read*2 | \|\| | Add/Sub*4 | \|\| | Max*2 | | | | |
| Read*2 | \|\| | Add/Sub*4 | \|\| | Max*2 | \|\| | Rotate*2 | \|\| | Store*2 |
| Read*2 | \|\| | Add/Sub*4 | \|\| | Max*2 | \|\| | Rotate*2 | \|\| | Store*2 |
| : | | | | | | | | |
| Read*2 | \|\| | Add/Sub*4 | \|\| | Max*2 | \|\| | Rotate*2 | \|\| | Store*2 |
| | | Add/Sub*4 | \|\| | Max*2 | \|\| | Rotate*2 | \|\| | Store*2 |
| | | | | Max*2 | \|\| | Rotate*2 | \|\| | Store*2 |

Output trellis 32 bits

Instructions underlined with a single underline form part of a first pipeline. Instructions underlined with a double underline form part of a second pipeline.

Therefore, according to some embodiments of the present invention, a code generator to produce this Viterbi algorithm code may include code having the following format:

For (I=0; I<Butterfly_Num; I++)
{

print “Read*2”
If (I>0) print “Add/Sub*4”
If (I>1) print “Max*2”
If (I>2) print “Rotate*2 || Store*2”
If (I%16==3 & I>0) print “Output trellis”

}Loop end
print “Add/Sub*4 || Max*2 || Rotate*2 || Store*2”
print “Max*2 || Rotate*2 || Store*2”
print “Rotate*2 || Store*2”
print “Output trellis”

In a second example, the processor architecture supports butterfly calculations in the following manner. This architecture will have a computational pipeline and will perform a complete butterfly calculation in 3 cycles if loading of a branch metric register (b₁₃ mreg) is not necessary or 4 cycles if branch metric register loading is required. In this example, the trace bits are stored in two output registers of 16 bits each. In this example, the butterfly calculations in Viterbi algorithm code will have the following format, where each line of code is a single cycle, ∥ indicates instructions that occur in parallel, ? indicates that the line of code may not be needed, and & indicates that the parameter of the following instruction which is being executed in the same cycle is either an output flag from a previous instruction or data read from memory in the previous instruction:

load bm_reg
Read & Add/Sub*2 bm_reg
Read & Add/Sub*2
Max*2 || Rotate*2
:
? load bm_reg
Read & Add/Sub*2
Read & Add/Sub*2
Max*2 & Rotate*2 || Store*2
:
Store*2

Output trellis 32 bits

Therefore, according to some embodiments of the present invention, a code generator to produce this Viterbi algorithm code may include code having the following format:

For (I=0; I<Butterfly_Num; I++)
{

print “Read & Add/Sub*2”
print “Read & Add/Sub*2”
print “Max*2 & Rotate*2”
If (I>0) print “|| Store*2”
If (I%16==0 & I>0) print “Output trellis 32 bits”

}Loop end
print “Store*2”
print “Output trellis 32 bits”

In a third example, the processor architecture supports butterfly calculations in the following manner. This architecture will perform butterfly calculations in 2 cycles and will have a computational pipeline of 5 cycles. In this example, the butterfly calculations in Viterbi algorithm code will have the following format, where each line of code is a single cycle, & indicates that the parameter following the instruction is data read from memory in the previous instruction, and ∥ indicates instructions that occur in parallel:

| | | | | | | |
|---|---|---|---|---|---|---|
| Read & Add/Sub*2 | | | | | | |
| Read & Add/Sub*2 | \|\| | Max | | | | |
| Read & Add/Sub*2 | \|\| | Max | | | | |
| Read & Add/Sub*2 | \|\| | Max | \|\| | Rotate | \|\| | Store |
| : | | | | | | |
| Read & Add/Sub*2 | \|\| | Max | \|\| | Rotate | \|\| | Store |
| | | Max | \|\| | Rotate | \|\| | Store |
| | | | | Rotate | \|\| | Store |
| | | | | Rotate | \|\| | Store |
| Output trellis | | | | | | |

Instructions underlined with a single underline implement the add-compare-select function for half of the butterfly. Instructions underlined with a double underline implement the add-compare-select function for the other half of the butterfly. Together, a single butterfly calculation requires 2 cycles.

Therefore, according to some embodiments of the present invention, a code generator to produce this Viterbi algorithm code may include code having the following format:

For (I=0; I<Butterfly_Num; I++)
{

print “Read & Add/Sub*2”
if (I>0) print “ || Max”
if (I>1) print “ || Rotate || Store”
print “\n”
print “Read & Add/Sub*2 || Max”
if (I>=1) print “ || Rotate || Store”

}Loop end

| | | | | | |
|---|---|---|---|---|---|
| print “ | Max | \|\| | Rotate | \|\| | Store” |
| print “ | | | Rotate | \|\| | Store” |
| print “ | | | Rotate | \|\| | Store” |

print “Output trellis”

It will be understood by persons of ordinary skill in the art that the scope of the present invention is not limited to the preceding examples. Rather, many other code generator formats to produce Viterbi algorithm code for butterfly calculations are also included in the scope of the present invention. The principles for developing the code generator formats are related to the add-compare-select process of butterfly calculations and to the relevant architectural features of the processor that is to execute the Viterbi algorithm code.

### Branch Metric Selection

It will be appreciated by persons of ordinary skill in the art that the examples of code formats for the code generator given hereinabove are incomplete outlines. For example, the instructions have operands that have not been specified in the outlines. In another example, a complete butterfly computation involves two addition instructions and two subtraction instructions. The outlines have merely specified “Add/Sub*4” or “Add/Sub*2” and have not specified the order in which the addition and subtraction instructions are to appear in the assembly code. Principles for determining how to specify the branch metric operands of the addition and subtraction instructions, and for determining in what order the addition and subtraction instructions are to appear, will now be described.

As is well known in the art, at a given transition between states, there is a fixed set of possible values for the branch metric values of each butterfly in the transition. For example, in the case of rate ⅓, the set of possible branch metric values are the eight linear combinations with coefficients +1 and −1 of the soft decisions of the three received bits a, b and c:

+a+b+c, +a+b−c, +a−b+c, +a−b−c

−a−b−c, −a−b+c, −a+b−c, −a+b+c.

It will be appreciated by persons of ordinary skill in the art that the second four linear combinations are listed above are the negative of the first four linear combinations. Therefore, when a data symbol is received, it is sufficient to calculate the first four linear combinations, since if, for example, one needs to subtract the branch metric value −a−b+c, one may add the branch metric value +a−b+c instead. These four calculated possible branch metric values may be stored in registers, for example, in registers having the names “x0 ”, “y0”, “x1” and “y1”, respectively. In the code generator, an array of the register names may be defined, for example, as follows:

names[4]={“x0”,“y0”,“x1”,“y1”}

These eight linear combinations may be represented as strings:

+++, ++−, +−+, +−−

−−−, −−+, −+−,−++.

It is well known in the art how to produce these strings given the generator polynomials and the index of the butterfly.

If each “+” in the string is represented as 0, and each “−” in the string is represented as 1, then the eight linear combinations may be represented as the binary numbers: 000, 001, 010, 011, 111, 110, 101, 100. The first four of these binary numbers may be used as the index of the array of names of registers where the branch metric values are stored.

Referring again to FIG. 2, the butterfly calculation involves addition and subtraction instructions. In the exemplary butterfly shown in FIG. 2, the calculation for half of the butterfly has the addition instruction S₂ᵢ+BM precede the subtraction instruction S_{2i+I}−BM, and for the other half of the butterfly has the subtraction instruction S₂ᵢ−BM precede the addition instruction S_{2i+I}+BM. It is well known in the art how to determine the order of the addition and subtraction instructions given the generator polynomials and the index of the butterfly.

According to some embodiments of the present invention, a code generator to produce Viterbi algorithm code may include code having the following format appearing in a loop on all butterflies:

/* Get the string for the Branch Metric value */

/* If the string starts with ‘−’, then take the negative of the string and set the negation flag */

/* Convert the string into a binary number N */

/* Determine whether addition precedes subtraction */

/* If negation flag set, change order of addition and subtraction */

/* Print addition and subtraction instructions in correct order using branch metric value stored at index N of names array */

### Cyclic Buffers

Certain processors may have two-operand instructions where one of the input registers is also an output register. For example, when the maximum instruction has only two operands, then the programmer is unable to use the same output register for the maximum instruction in each cycle. This is illustrated by the following example of code:

$$\frac{Add a0 , a1 , a2}{Add a0 , a1 , a2} \begin{matrix}‖ \\ ‖\end{matrix} \frac{Sub a0 , a1 , a3}{Sub a0 , a1 , a3} \begin{matrix} \\ ‖\end{matrix} \begin{matrix} \\ \underline{Max a2 , a3}\end{matrix}$$

Some of the instructions are underlined to indicate that they belong to the same computational pipeline. In the second line of code, both the Sub and Max instructions are writing to the same register, a3. This will not yield the desired result.

According to an embodiment of the present invention, alternating sets of output registers may be used when an instruction has two operands. Viterbi algorithm assembly code may have the following format, for example:

| | | | | | | |
|---|---|---|---|---|---|---|
| Add a0, a1, a2 | \|\| | Sub a0, a1, a3 | | | | |
| Add a0, a1, a4 | \|\| | Sub a0, a1, a5 | \|\| | Max a2, a3 | | |
| Add a0, a1, a2 | \|\| | Sub a0, a1, a3 | \|\| | Max a4, a5 | \|\| | Store a3 |
| Add a0, a1, a4 | \|\| | Sub a0, a1, a5 | \|\| | Max a2, a3 | \|\| | Store a5 |
| Add a0, a1, a2 | \|\| | Sub a0, a1, a3 | \|\| | Max a4, a5 | \|\| | Store a3 |

Instructions underlined with a single underline form part of a first pipeline. Instructions underlined with a double underline form part of a second pipeline.

Therefore, according to some embodiments of the present invention, a code generator to produce this Viterbi algorithm code may include code to implement a cyclic pointer that points to one of two alternating sets of output registers ({a2,a3}, {a4,a5}) and is cyclically incremented as the loop on butterflies is performed.

A cyclic buffer is also helpful for the case of a processor architecture having two cycles per instruction. In this case every modified register is ready to be used as a parameter of any following instruction at least with one cycle gap. The output flag of the maximum instruction may be used immediately. In a non-limiting example, a processor may perform butterfly calculations in 2 cycles and have a computational pipeline of 8 cycles. The Viterbi algorithm assembly code for this example may include code having the following format:

| | | | | | | | | |
|---|---|---|---|---|---|---|---|---|
| Read a0 | | | | | | | | |
| Read a4 | | | | | | | | |
| Read a0 | \|\| | Add a0, a8, a1 | \|\| | Sub a0, a8, a2 | | | | |
| Read a4 | \|\| | Add a4, a8, a5 | \|\| | Sub a4, a8, a6 | | | | |
| Read a0 | \|\| | Add a0, a8, a1 | \|\| | Sub a0, a8, a2 | \|\| | Max a1, a2, a3 | | |
| Read a4 | \|\| | Add a4, a8, a5 | \|\| | Sub a4, a8, a6 | \|\| | Max a5, a6, a7 | \|\| | Rotate a12 |
| Read a0 | \|\| | Add a0, a9, a1 | \|\| | Sub a0, a9, a2 | \|\| | Max a1, a2, a3 | \|\| | Store a3 |

|| Rotate a13

| | | | | | | | | |
|---|---|---|---|---|---|---|---|---|
| Read a4 | \|\| | Add a4, a9, a5 | \|\| | Sub a4, a9, a6 | \|\| | Max a5, a6, a7 | \|\| | Store a7 |

|| Rotate a12

Instructions having a single underline belong to the same add-compare-select (i.e. half of a butterfly) calculation. According to this embodiment of the present invention, the cyclic pointer alternates between the following two sets of registers:

({a0,a1,a2,a3,a12}, {a4,a5,a6,a7,a13}).

### Generating a Description of a Viterbi Accelerator

In other embodiments of the present invention, the method shown in FIG. 1 may be used, where the code generator creates a description of a Viterbi hardware accelerator. Rather than having the code generator produce Viterbi algorithm code in assembly language or some other software language, the code generator may use a hardware description language, such as, for example, VHDL or VERILOG. Such a code generator may then produce a description in hardware description language of a Viterbi hardware accelerator for the desired generator polynomials and other Viterbi algorithm parameters.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A computer-readable medium storing computer-readable code, which when executed by a computer, causes said computer to generate assembly code for use in a general-purpose processor, the assembly code implementing a Viterbi algorithm.

2. The computer-readable medium of claim 1, wherein said computer-readable code comprises:
a first code segment to receive parameters of said Viterbi algorithm;
a second code segment to automatically generate assembly code instructions to perform add-compare-select calculations according to said parameters; and
a third code segment to automatically generate identifiers of physical components where branch metric values to be used in said calculations are to be stored.

3. The computer-readable medium of claim 2, wherein said computer-readable code further comprises:
a fourth code segment to automatically generate identifiers of output registers for use with instructions having only two operands.

4. A computer-readable medium storing computer-readable code, which when executed by a computer, causes said computer to generate a hardware description of a Viterbi accelerator.

5. The computer-readable medium of claim 4, wherein said computer-readable code comprises:
a first code segment to receive parameters of a Viterbi algorithm to be implemented by said accelerator;
a second code segment to automatically generate a hardware description of components of said accelerator to perform add-compare-select calculations according to said parameters; and
a third code segment to automatically generate a hardware description of physical components where branch metric values to be used in said calculations are to be stored.

6. A method for automatically generating assembly code for use in a general-purpose processor, the assembly code implementing a Viterbi algorithm, the method comprising:
receiving parameters of said Viterbi algorithm;
automatically generating assembly code instructions of said processor to perform add-compare-select calculations according to said parameters; and
automatically generating identifiers of physical components of said processor used to store branch metric values to be used in said calculations.

7. A method for automatically generating a hardware description of a Viterbi accelerator, the method comprising:
receiving parameters of a Viterbi algorithm to be implemented by said accelerator;
automatically generating a hardware description of components of said accelerator to perform add-compare-select calculations according to said parameters; and
automatically generating identifiers of physical components used to store branch metric values to be used in said calculations.

8. A code generator to generate generating assembly code for use in a general-purpose processor, the assembly code implementing a Viterbi algorithm, the code generator comprising:
means for receiving parameters of said Viterbi algorithm;
means for automatically generating assembly code instructions of said processor to perform add-compare-select calculations according to said parameters; and
means for automatically generating identifiers of physical components of said processor used to store branch metric values to be used in said calculations.

9. A hardware description generator to automatically generate a hardware description of a Viterbi accelerator, the generator comprising:
means for receiving parameters of a Viterbi algorithm to be implemented by said accelerator;
means for automatically generating a hardware description of components of said accelerator to perform add-compare-select calculations according to said parameters; and
means for automatically generating identifiers of physical components used to store branch metric values to be used in said calculations.
